(19) United States
(12) Patent Application Publication
(10) Pub. No.: US 2011/0244193 A1
(43) Pub. Date: Oct. 6, 2011

(54) Folded Core Having a High Compression Modulus and Articles Made from the Same

(75) Inventors: Rainer Kehrle, Stuttgart (DE); Yves Klett, Dauchigen (DE); Mikhail R. Levit, Glen Allen, VA (US); Olivier Lengwiler, Vich (CH)

(73) Assignee: E.I. DU PONT DE NEMOURS AND COMPANY, Wilmington, DE (US)

(21) Appl. No.: 12/894,459

(22) Filed: Sep. 30, 2010

Related U.S. Application Data
(63) Continuation-in-part of application No. 12/542,766, filed on Aug. 18, 2009, now abandoned.
(60) Provisional application No. 61/189,620, filed on Aug. 21, 2008.

(51) Int. Cl. B32B 3/28; B32B 5/02; B32B 27/04

(52) U.S. Cl. 428/175

(57) ABSTRACT

This invention is directed to a folded tessellated core structure having a high compression modulus. The core structure comprises a nonwoven sheet and a cured resin in an amount such that the weight of cured resin as a percentage of combined weight of cured resin and nonwoven sheet is at least 50 percent, The nonwoven sheet further comprises fibers having a modulus of at least 200 grams per denier (180 grams per dtex) and a tenacity of at least 10 grams per denier (9 grams per dtex) wherein, prior to impregnating with the resin, the nonwoven sheet has an apparent density calculated from the equation Dp=K×((dr×(100−% r)/% r)/(1+dr/ds×(100−% r)% r), where Dp is the apparent density of the sheet before impregnation, dr is the density of cured resin, ds is the density of solid material in the sheet before impregnation, % r is the cured resin content in the final core structure in weight %, K is a number with a value from 1.0 to 1.5, Further, the Gurley porosity of the nonwoven sheet before impregnation with the resin is no greater than 30 seconds per 100 milliliters. The invention is also directed to composite structures incorporating such folded core.

### RELATED US APPLICATION DATA

This application is a continuation-in-part of application Ser. No. 12/542,766 filed on Aug. 18, 2009 which was a non-provisional application of provisional application Ser. No. 61/189,620 filed on Aug. 21, 2008.

### BACKGROUND OF THE INVENTION

1. Field of the Invention

This invention relates to a high compression modulus folded core structure.

2. Description of Related Art

Core structures for sandwich panels from high modulus high strength fiber nonwoven sheets, mostly in the form of honeycomb, are used in different applications but primarily in the aerospace industry where strength to weight or stiffness to weight ratios have very high values. For example, U.S. Pat. No. 5,137,768 to Lin describes a honeycomb core made from a high-density wet-laid nonwoven comprising 50 wt. % or more of p-aramid fiber with the rest of the composition being a binder and other additives.

A commercially available high modulus high strength fiber nonwoven sheet for the production of core structures is KEVLAR® N636 paper sold by E. I. DuPont de Nemours and Company, Wilmington, Del. The paper density for the lightest grade (1.4N636) ranges from 0.68 to 0.82 g/cm³. For three other grades (1.8N636, 2.8N636, and 3.9N636) the density range is from 0.78 to 0.92 g/cm³.

Folded core structures can be made in a much more economical way in comparison with traditional honeycomb structures. There are some applications, in which enhancement of compression properties is very important. This is particularly true for sandwich panels used in flooring for aircraft, trains, etc. Potentially, a folded core optimized for compression modulus (stiffness) and/or shear strength can provide additional weight and cost savings. Therefore what is needed is a folded core structure with improved compression modulus.

### BRIEF SUMMARY OF THE INVENTION

This invention is directed to a folded core structure having a high compression modulus. The core structure comprises a plurality of folded tessellated configurations, said tessellated configurations further comprising a nonwoven sheet and a cured resin in an amount such that the weight of cured resin as a percentage of combined weight of cured resin and nonwoven sheet is at least 50 percent, The nonwoven sheet further comprises fibers having a modulus of at least 200 grams per denier (180 grams per dtex) and a tenacity of at least 10 grams per denier (9 grams per dtex) wherein, prior to impregnating with resin, the nonwoven sheet has an apparent density calculated from the equation Dp=K×((dr×(100−% r)/% r)/(1+dr/ds×(100−% r)% r), where Dp is the apparent density of the sheet before impregnation, dr is the density of cured resin, ds is the density of solid material in the sheet before impregnation, % r is the cured resin content in the final core structure in weight %, K is a number with a value from 1.0 to 1.5. Further, the Gurley porosity of the nonwoven sheet before impregnation with the resin is no greater than 30 seconds per 100 milliliters.

The invention is further directed to a composite panel containing a folded core structure.

### BRIEF DESCRIPTION OF THE DRAWINGS

FIG. 1 is an illustration of a folded core structure.

### DETAILED DESCRIPTION OF THE INVENTION

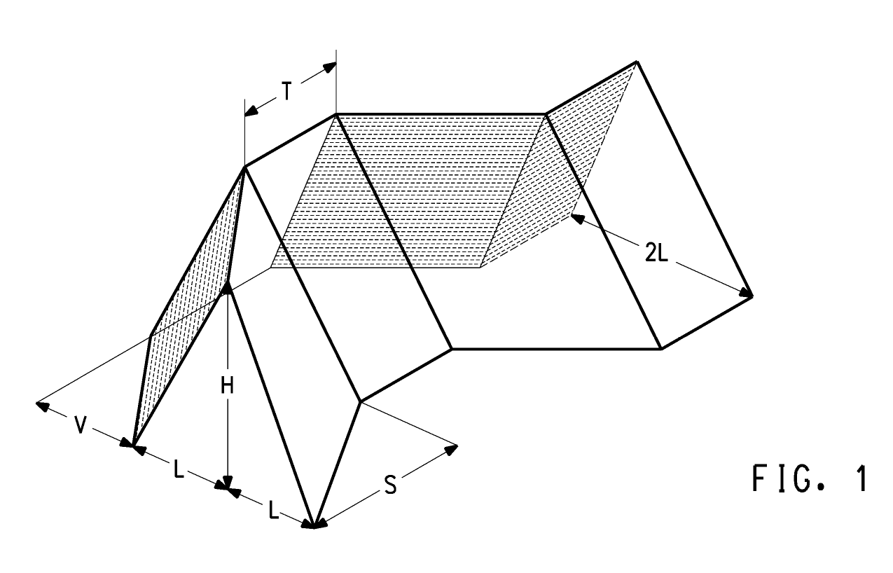

This invention is directed to a folded core structure having a high compression modulus. A folded core is a 3-dimensional structure of folded geometric patterns folded from a relatively thin planar sheet material. An example of a folded structure is shown in FIG. 1. Such folded or tessellated sheet structures are discussed in U.S. Pat. Nos. 6,935,997 B2 and 6,800,351 B1. A chevron is a common pattern for three dimensional folded tessellated core structures. Such structures are different from honeycomb structures. A preferred tessellated folded structure is of the type described in U.S. Pat. No. 6,913,570 B2.

The folded tessellated core structure comprises a nonwoven fibrous sheet that has been coated or impregnated with a thermoset resin. The folded core of the present invention has a resin content of at least 50 wt. % of the total weight of sheet material plus resin coat. The nonwoven sheet apparent density before impregnation with resin is defined by the equation:

Dp=K×((dr×(100−% r)/% r)/(1+dr/ds×(100−% r)/% r)

where Dp is the apparent density of the nonwoven paper sheet before impregnation, dr is the density of cured resin, ds is the density of solid material in the nonwoven sheet before impregnation, % r is the cured resin content in the final core structure in weight %, and K is a number (K value) from 1 to 1.5.

In a further embodiment, the nonwoven sheet apparent density before impregnation with resin is defined by the equation:

Dp=K×((dr×(100−% r)/% r)/(1+dr/ds×(100−% r)/% r)

where Dp is the apparent density of the nonwoven paper sheet before impregnation, dr is the density of cured resin, ds is the density of solid material in the nonwoven sheet before impregnation, % r is the cured resin content in the final core structure in weight %, and K is a number with a value from 1.1 to 1.5.

In yet another embodiment, the nonwoven sheet apparent density before impregnation with resin is defined by the equation:

Dp=K×((dr×(100−% r)/% r)/(1+dr/ds×(100−% r)/% r)

where Dp is the apparent density of the nonwoven paper sheet before impregnation, dr is the density of cured resin, ds is the density of solid material in the nonwoven sheet before impregnation, % r is the cured resin content in the final core structure in weight %, and K is a number with a value from 1.2 to 1.3.

The nonwoven sheet before impregnation with resin has a Gurley air resistance not exceeding 30 seconds per 100 milliliters.

The high sheet material permeability allows good penetration of resin into the sheet material during the resin impregnation process such that the thickness of the sheet after coating is not significantly different from the uncoated nonwoven sheet thickness.

The free volume/void content of the nonwoven sheet folded core can be measured based on apparent density of the nonwoven sheet and density of solid materials in the nonwoven sheet or by image analysis of the sheet cross-section.

The thickness of the nonwoven sheet used in this invention is dependent upon the end use or desired properties of the folded core and in some embodiments is typically from 3 to 20 mils (75 to 500 micrometers) thick. In some embodiments, the basis weight of the nonwoven sheet is from 0.5 to 6 ounces per square yard (15 to 200 grams per square meter).

The nonwoven sheet used in the folded core of this invention comprises 70 to 100 parts by weight of a high modulus high strength fiber having an initial Young's modulus of at least 200 grams per denier (180 grams per dtex), a tenacity of at least 10 grams per denier (9 grams per dtex) and no more than 30 wt. % of a binder.

Different materials can be used as the nonwoven sheet binder depending on the final end-use. Preferable binders include poly (m-phenylene isophthalamide), poly (p-phenylene terephthalamide), polysulfonamide (PSA), poly-phenylene sulfide (PPS), and polyimides. Different high modulus high strength fibers in the form of the continuous fiber, cut fiber (floc), pulp or their combination can be used in the high modulus high strength fiber nonwoven sheet of the folded core of this invention. Preferable types of fibers include p-aramid, liquid crystal polyester, polybenzazole, polypyridazole, polysulfonamide, polyphenylene sulfide, polyolefins, carbon, glass and other inorganic fibers or mixture thereof.

As employed herein the term aramid means a polyamide wherein at least 85% of the amide (—CONH—) linkages are attached directly to two aromatic rings. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. Para aramid fibers and various forms of these fibers are available from E. I. du Pont de Nemours and Company, Wilmington, Del. under the trademark Kevlar® and from Teijin, Ltd., under the trademark Twaron®. Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, both available from Toyobo Co. Inc., Osaka, Japan. Commercially available carbon fibers useful in this invention include Tenax® fibers available from Toho Tenax America, Inc, Rockwood, Tenn. Commercially available liquid crystal polyester fibers useful in this invention include Vectran® HS fiber available from Kuraray America Inc., New York, N.Y.

The nonwoven sheet of the folded core structure of this invention can also include fibers of lower strength and modulus blended with the higher modulus fibers. The amount of lower strength fiber in the blend will vary on a case by case basis depending on the desired strength of the folded core structure. The higher the amount of low strength fiber, the lower will be the strength of the folded core structure. In a preferred embodiment, the amount of lower strength fiber should not exceed 30%. Examples of such lower strength fibers are meta-aramid fibers and poly (ethylene therephtalamide) fibers.

The nonwoven sheet of the folded core of this invention can contain small amounts of inorganic particles and representative particles include mica, vermiculite, and the like; the addition of these performance enhancing additives being to impart properties such as improved fire resistance, thermal conductivity, dimensional stability, and the like to the nonwoven sheet and the final folded core structure.

The preferable type of the nonwoven sheet used for the folded core of this invention is paper or wet-laid nonwoven. However, nonwovens made by other technologies including needle punching, adhesive bonding, thermal bonding, and hydroentangling can also be used.

The paper (wet-laid nonwoven) used to make the folded core of this invention can be formed on equipment of any scale, from laboratory screens to commercial-sized papermaking machinery, including such commonly used machines as Fourdrinier or inclined wire paper machines. A typical process involves making a dispersion of fibrous material such as floc and/or pulp and a binder in an aqueous liquid, draining the liquid from the dispersion to yield a wet composition and drying the wet paper composition. The dispersion can be made either by dispersing the fibers and then adding the binder or by dispersing the binder and then adding the fibers. The final dispersion can also be made by combining a dispersion of fibers with a dispersion of the binder; the dispersion can optionally include other additives such as inorganic materials. The concentration of fibers in the dispersion can range from 0.01 to 1.0 weight percent based on the total weight of the dispersion. The concentration of the binder in the dispersion can be up to 30 weight percent based on the total weight of solids. In a typical process, the aqueous liquid of the dispersion is generally water, but may include various other materials such as pH-adjusting materials, forming aids, surfactants, defoamers and the like. The aqueous liquid is usually drained from the dispersion by conducting the dispersion onto a screen or other perforated support, retaining the dispersed solids and then passing the liquid to yield a wet paper composition. The wet composition, once formed on the support, is usually further dewatered by vacuum or other pressure forces and further dried by evaporating the remaining liquid.

In one preferred embodiment, the fiber and the polymeric binder can be slurried together to form a mix that is converted to paper on a wire screen or belt. Reference is made to U.S. Pat. Nos. 4,698,267 and 4,729,921 to Tokarsky; 5,026,456 to Hesler et al.; 5,223,094 and 5,314,742 to Kirayoglu et al for illustrative processes for forming papers from various types of fiber material and polymeric binders.

Once the paper is formed, it is calendered to the desired density or left uncalendered depending on the target final density.

In the latter case, some adjustments of density can be performed during forming by optimizing vacuum on the forming table and pressure in wet presses.

Floc is generally made by cutting continuous spun filaments into specific-length pieces. If the floc length is less than 2 millimeters, it is generally too short to provide a paper with adequate strength; if the floc length is more than 25 millimeters, it is very difficult to form uniform wet-laid webs. Floc having a diameter of less than 5 micrometers, and especially less than 3 micrometers, is difficult to produce with adequate cross sectional uniformity and reproducibility; if the floc diameter is more than 20 micrometers, it is very difficult to form uniform papers of light to medium basis weights.

The term “pulp”, as used herein, means particles of fibrous material having a stalk and fibrils extending generally therefrom, wherein the stalk is generally columnar and about 10 to 50 micrometers in diameter and the fibrils are fine, hair-like members generally attached to the stalk measuring only a fraction of a micrometer or a few micrometers in diameter and about 10 to 100 micrometers long. One possible illustrative process for making aramid pulp is generally disclosed in U.S. Pat. No. 5,084,136.

One of the preferred types of the binder for the wet-laid nonwoven of this invention is fibrids.

The term “fibrids” as used herein, means a very finely-divided polymer product of small, filmy, essentially two-dimensional particles having a length and width on the order of 100 to 1000 micrometers and a thickness on the order of 0.1 to 1 micrometer. Fibrids are typically made by streaming a polymer solution into a coagulating bath of liquid that is immiscible with the solvent of the solution. The stream of polymer solution is subjected to strenuous shearing forces and turbulence as the polymer is coagulated.

Preferable polymers for fibrids in this invention include aramids (poly (m-phenylene isophthalamide), poly (p-phenylene terephthalamide)).

Processes for converting web substrates into folded core structures are described in U.S. Pat. Nos. 6,913,570 B2 and 7,115,089 B2 as well as US patent application 2007/0141376.

Usually, the process of making the folded core comprises steps of a) forming a repeating pattern of fold lines in the raw web material; b) initiating the formation of folds; c) further formation of the folds; d) stabilizing the three-dimensional folded configuration.

The resin impregnation on the nonwoven sheet may be applied before forming the folded core shape or after core folding has been completed. A two stage impregnation process can also be used in which part of the resin is impregnated into the nonwoven sheet before shape forming and the balance impregnated after shape forming. When the resin impregnation of the nonwoven sheet is conducted prior to shape forming it is preferred that the resin is partially cured. Such a partial curing process, known as B-staging, is well known in the composite materials industry. By B-stage we mean an intermediate stage in the polymerization reaction in which the resin softens with heat and is plastic and fusible but does not entirely dissolve or fuse. The B-staged substrate is still capable of further processing into the desired folded core shape.

When the resin impregnation is conducted after the core has been folded, it is normally done in a sequence of repeating steps of dipping followed by solvent removal and curing of the resin. Such impregnation processes are similar to those employed to make honeycomb core structures. The preferred final core densities (nonwoven sheet plus resin) are in the range of 20 to 150 kg/m³. During the resin impregnation process, resin is absorbed into and coated onto the nonwoven sheet.

Depending on the final application of the folded core of this invention, different resins can be used to coat and impregnate the nonwoven sheet. Such resins include phenolic, epoxy, polyester, polyamide, and polyimide resins. Phenolic and polyimide resins are preferable. Phenolic resins normally comply with United States Military Specification MIL-R-9299C. Combinations of these resins may also be utilized. Suitable resins are available from companies such Hexion Specialty Chemicals, Columbus, Ohio or Durez Corporation, Detroit, Mich.

Folded core of the above invention may be used to make composite panels having facesheets bonded to at least one exterior surface of the folded core structure. The facesheet material can be a plastic sheet or plate, a fiber reinforced plastic (prepreg) or metal. The facesheets are attached to the core structure under pressure and usually with heat by an adhesive film or from the resin in the prepreg. The curing is carried out in a press, an oven or an autoclave. Such techniques are well understood by those skilled in the art.

### Test Methods

Apparent Density of the nonwoven sheet was calculated using the nonwoven sheet thickness as measured by ASTM D645-97 at a pressure of about 50 kPa and the basis weight as measured by ASTM D646-96. Fiber denier was measured using ASTM D1907-07.

Gurley Air Resistance (porosity) for the nonwoven sheets was determined by measuring air resistance in seconds per 100 milliliters of cylinder displacement for approximately 6.4 square centimeters circular area of a paper using a pressure differential of 1.22 kPa in accordance with TAPPI T460.

Density of the folded core was determined in accordance with ASTM C271-61.

Compression strength and compression modulus of the core was determined in accordance with ASTM C365-57.

Specific compression strength and specific compression modulus of the core was calculated by dividing compression strength and compression modulus values by the density of the core.

### EXAMPLES

### Example 1

A high modulus high strength fiber nonwoven sheet comprising 81 weight % p-aramid floc and 19 weight % meta-aramid fibrids was formed on conventional paper forming equipment. The para-aramid floc was Kevlar®49 having a nominal filament linear density of 1.5 denier per filament (1.7 dtex per filament), a 6.4 mm cut length, a tenacity of 24 grams per denier and a modulus of 960 grams per denier. Such fiber is available from E. I. DuPont de Nemours and Company, Wilmington, Del. The meta-aramid fibrids were prepared as described in U.S. Pat. No. 3,756,908 to Gross.

The nonwoven sheet was then calendered to produce the final sheet with an apparent density of 0.50 g/cm³, a basis weight 2.5 oz per square yard (85 grams per square meter) and a Gurley porosity of 2 seconds per 100 milliliters. The nonwoven sheet apparent density of 0.50 g/cm³ was targeted for the resin content of about 65 wt. % in the final core based on the equation:

Dp=K×((dr×(100−% r)/% r)/(1+dr/ds×(100−% r)/% r)

Where Dp is the apparent density of the nonwoven sheet before impregnation, dr is the density of cured resin (1.25 g/cm³), ds is the density of solid material in the nonwoven sheet before impregnation (1.4 g/cm3) % r is the matrix resin content in the final core in weight %, and K is a number with a value from 1.0 to 1.5.

The calendered nonwoven sheet was impregnated with a resole type phenolic resin having a solids content of 35 wt. % and a viscosity of 70 mPa*sec., the solvent (methanol/Dowanol PM) was evaporated and the resin partially cured to a B-stage thus producing a resin impregnated nonwoven sheet (prepreg). A folded core was then formed from this pre-impregnated B-staged material in accordance with U.S. Pat. No. 6,913,570 to Kehrle. A zig-zag fold pattern as shown in FIG. 1 was made having geometrical parameters for the core of V=14.3, T=5, S=4.6 mm, L=10.6 mm and H=30.0 mm. The resin was completely cured by heat treatment of the final core at 180 C for 1.5 hours. The finished folded core structure had a density of 47.9 kg/m3 and a resin content of 68% of the total core weight. This structure corresponds to a K value of 1.22. The specific compression strength was 0.0189 (N/mm2)/(kg/m3) and the specific compression modulus was 1.14 (N/mm2)/(kg/m3). The key data is summarized in Table 1.

### Comparative Example 1

A high modulus high strength fiber nonwoven sheet was formed as in Example 1, but calendered to an apparent density of 0.85 g/cm3 and a basis weight of 2.5 oz per square yard (85 grams per square meter). The Gurley porosity of the sheet was about 5 seconds.

The nonwoven sheet was then converted into a folded core structure as in Example 1. The geometrical parameters of this core were exactly the same as in Example 1 except that the height was 30.13 mm. The finished folded core structure had a density of 50.9 kg/m3 and a resin content of 70% of the total core weight. This structure corresponds to a K value of 2.18. The specific compression strength was 0.0197 (N/mm2)/(kg/m3) and the specific compression modulus was 0.58 (N/mm2)/(kg/m3). The key data is summarized in Table 1.

TABLE 1

| | Resin | Range of optimum | | Specific compression | Specific compression | |
|---|---|---|---|---|---|---|
| | content, | density of | Apparent density of | strength, | modulus, | K |
| Example | wt. % | nonwoven, (g/cm³) | nonwoven, (g/cm³) | (N/mm²)/(kg/m³) | (N/mm²)/(kg/m³) | Value |
| 1 | 68 | 0.41-0.62 | 0.50 | 0.0189 | 1.14 | 1.22 |
| Comp. 1 | 70 | 0.39-0.58 | 0.85 | 0.0197 | 0.58 | 2.18 |

As can be seen from the summary in Table 1, the folded core structure of Example 1 having a nonwoven sheet optimized, in accordance with this invention, for apparent density and resin penetration into the nonwoven sheet, gave double the compression modulus (stiffness) in comparison with the folded core structure of Comparative Example 1 made from a higher density nonwoven sheet representative of the prior art. The compression strength of both cores was similar. This confirms that the optimization of both the density of the nonwoven sheet used to make the folded core structure and the resin content impregnated into the nonwoven sheet results in a significant improvement in compression modulus.

What is claimed is:

1. A core structure comprising a plurality of folded tessellated configurations, said folded tessellated configurations further comprising:
(a) a nonwoven sheet comprising fibers having a modulus of at least 200 grams per denier (180 grams per dtex) and a tenacity of at least 10 grams per denier (9 grams per dtex) wherein, prior to impregnating with a resin:
(1) said nonwoven sheet has an apparent density calculated from the equation Dp=K×((dr×(100−% r)/% r)/(1+dr/ds×(100−% r)/% r), where Dp is the apparent density of the nonwoven sheet before impregnation, dr is the density of cured resin, ds is the density of solid material in the nonwoven sheet before impregnation, % r is the cured resin content in the final core structure in weight %, K is a number with a value from 1.0 to 1.5
(2) said nonwoven sheet has a Gurley porosity no greater than 30 seconds per 100 milliliters and:
(b) a cured resin in an amount such that the weight of cured resin as a percentage of combined weight of cured resin and nonwoven sheet is at least 50 percent.

2. The core structure of claim 1 wherein the nonwoven sheet comprises 70-100 wt. % of fiber and 0-30 wt. % of a binder.

3. The core structure of claim 2 wherein the nonwoven sheet is a wet-laid nonwoven sheet.

4. The core structure of claim 2 wherein the binder comprises m-aramid fibrids.

5. The core structure of claim 2 wherein the fiber comprises p-aramid fiber.

6. The core structure of claim 1 wherein nonwoven sheet has an apparent density calculated from the equation Dp=K×((dr×(100−% r)/% r)/(1+dr/ds×(100−% r)/% r), where Dp is the apparent density of the nonwoven sheet before impregnation, dr is the density of cured resin, ds is the density of solid material in the nonwoven sheet before impregnation, % r is the cured resin content in the final core structure in weight %, K is a number with a value from 1.1 to 1.5.

7. The core structure of claim 6 wherein, K is a number with a value from 1.2 to 1.3.

8. A composite panel comprising a core structure according to any one of the preceding claims and at least one facesheet attached to at least one exterior surface of said core structure.

9. The structural panel according to claim 6, wherein said facesheet is made from resin impregnated fiber, plastic or metal.
